(19) United States
(12) Patent Application Publication
(10) Pub. No.: US 2006/0244578 A1
(43) Pub. Date: Nov. 2, 2006

(54) Vehicle trailer hitch alignment device

(76) Inventor: John Carl Martin, Bradenton, FL (US)

Correspondence Address: JOHN C. MARTIN, 508 - 51ST AVENUE PLAZA WEST, BRADENTON, FL, 34207, US

(21) Appl. No.: 11/386,953

(22) Filed: Mar. 22, 2006

Related U.S. Application Data
(60) Provisional application No. 60/675,735, filed on Apr. 28, 2005.

(51) Int. Cl. G08B 21/00

(52) U.S. Cl. 340/431

(57) ABSTRACT

The invention guides the driver of a tow vehicle when backing up to hook up a trailer. The invention uses a pole-mounted indicator light that is fastened to the hitch area of the trailer and powered from an internal battery. The pole-mounted light is elevated approximately 3 feet above the hitch, such that it is visible over the tailgate of a pick up truck or from the rear window of an suv or other vehicles. An adjustable arm is attached to the indicator light pole that folds down at a 90 degree angle and projects beyond the hitch area. When the tow vehicle backs up, it contacts a pressure activated limit switch when the hitch ball is directly underneath the trailer hitch. When activated the switch illuminates the indicator light, then the driver can use the indicator light to properly back & center vehicle over the hitch.

### CROSS REFERENCES TO RELATED APPLICATIONS

This application relates to the U.S. provisional patent application filed by the same inventor on Apr. 28, 2005 for substantially the same subject matter, entitled “vehicle trailer hitch alignment device” and having a Ser. No. of 60/675,735. i claim all appropriate benefit from this previously filed application.

### FIELD OF THE INVENTION

The present invention relates generally to vehicle trailer alignment device for guiding the operator of a tow vehicle to attach a trailer and, more particularly, the present invention relates to a vehicle trailer hitch alignment device for safely and quickly aligning a tow vehicle to a trailer when coupling them together and eliminating the need of an additional human guidance.

### DESCRIPTION OF THE RELATED ART

As anyone who has ever towed a trailer can tell you, it is a trying and stressful experience. There are many factors to consider and remember even before the trailer begins to move. These include load distribution, proper hookup, weight capacities, hitch capacities, electrical light hookups, and so forth. Once the vehicle begins to move, the driver must deal with increased reaction times, lane clearances, high winds, reduced gas mileage, and so forth. But perhaps the biggest aggravation is the initial coupling of the tow vehicle to the trailer. This usually takes two people since the driver cannot see the hitch and even then it usually takes two or three attempts since the driver must suffer with the delayed reaction time for the second person to relay the proper direction and distance.

The present scenario is thus punctuated by an emerging need to develop a means by which one person can safely and quickly align a tow vehicle to a trailer when coupling them together.

With a view to effectively combat the inherent drawbacks in the already existing conventional protocols for trailer alignment in context of towing, the present invention intends to provide a highly effective and efficient means for self monitored tow vehicle alignment with entire maneuver being carried out by one person, and, thereby eliminating the necessity of an additional person to assist in trailer alignment, and thus ensuring enhanced levels of convenience and utility in addition to reduction in time and an extra person intervention.

### BRIEF SUMMARY OF INVENTION

Therefore the object of the invention is to provide a device, the usage of which ensures an easy, effective and time saving means of trailer alignment in towing with monitoring being done by only one person.

To achieve the above and other objects, the present invention provides an apparatus for overcoming the inherent drawbacks in trailer alignment in conventional towing protocols.

It is further an object of the present invention to provide a method whereby the usage of the instant invention ensures time effectiveness as well as reduction in number of additional person.

It is further an object of the present invention to provide a vehicle trailer hitch alignment device for aligning a vehicle hitch to a trailer comprising a light pole assembly having a first end and a second end, a light assembly for providing lighting arrangement detachably coupled to the light pole assembly at the first end, and a pressure switch assembly pivotally mounted towards the second end of the light pole assembly and electrically connected to the light assembly.

It is yet another object of the present invention to provide a light pole assembly for a vehicle trailer hitch alignment device having a light assembly and a pressure switch assembly, comprising, a first and second coaxial tubular longitudinal bodies having top ends, the first tubular body capable of sliding inside the second tubular body, an adjustable collar threadably attached to the second tubular body for regulating the sliding motion of the first tubular body inside the second tubular body thereby capable of adjusting the height of the light pole assembly.

It is yet another object of the present invention to provide a pressure switch assembly for a vehicle trailer hitch alignment device having a light assembly and a light pole assembly comprising an elongated cylindrical sleeve member attached to a sleeve support member pivotally coupled to the light pole assembly by a pivot pin, the sleeve member further having a threading means, a pressure switch arm having a first end and a second end, capable of adjustably sliding inside the cylindrical sleeve member regulated by the threading means and connected to a pressure switch at the first end, the pressure switch electrically connected to the light assembly and an absorbing means interiorly placed inside the pressure arm switch at the second end for absorbing any force acted upon the pressure arm;

It is further an object of the present invention to provide a method of aligning a tow vehicle hitch with a trailer having a coupling, using a vehicle trailer hitch alignment device having a pressure switch assembly, a light assembly and a light pole assembly, the method comprising mounting the device on a trailer, setting the distance of the pressure switch assembly having a pressure switch by pivotally orienting the pressure switch assembly, setting the height of the light pole assembly; and reversing the vehicle towards the trailer wherein as the vehicle comes in contact with the pressure switch of the pressure switch assembly provides an indication through the light assembly thereby indicating an operator that the vehicle hitch is in line with the coupling of the trailer.

As its name implies, the invention is an apparatus that guides the driver of a tow vehicle when backing up to hook up a trailer. The invention uses a pole-mounted indicator light that is fastened to the hitch area of the trailer and powered from the trailer electrical system or an internal battery. The pole-mounted light is elevated approximately 3 feet above the hitch, such that is visible over the tailgate area of the tow vehicle in the case of a pickup truck, or from the rear window in the case of other vehicles. An adjustable swing down arm is attached to the indicator light pole that folds down at a 90-degree angle and projects beyond the hitch area. When the tow vehicle backs up, it contacts a pressure activated limit switch when the hitch ball is directly underneath the trailer hitch. When activated, the switch closes the circuit and illuminates the indicator light. In such a manner the driver can use the indicator light to center the tow vehicle and also know how far to back the vehicle as well.

The use of the novel device allows for a foolproof method of backing up tow vehicles to trailers in a safe and secure manner without the aid of a second person.

### BRIEF DESCRIPTION OF THE DRAWING

The advantages and features of the present invention will become better understood with reference to the following more detailed description and claims taken in conjunction with the accompanying drawing, in which like elements are identified with like symbols, and in which:

The sole illustration herein is a side elevation view of the vehicle trailer hitch alignment device 10, according to a preferred embodiment of the present invention.

### DESCRIPTIVE KEY

| | | | |
|---|---|---|---|
| 10 | vehicle trailer hitch | 50 | light cover |
| | alignment device | 60 | light |
| 20 | outer pole mount | 70 | pressure switch sleeve |
| | sleeve | 75 | threading means |
| 30 | inner pole mount tube | 80 | pressure switch arm |
| 40 | adjustable collar | 90 | pressure switch |
| 100 | spring | 110 | sleeve support |
| 105 | pivot pin | | |

| | |
|---|---|
| 120 | battery housing |
| 130 | spring clip |
| 150 | trailer jack |
| 160 | trailer frame |
| 170 | trailer coupling |
| 180 | tow vehicle |
| 190 | tow vehicle hitch |

### DETAILED DESCRIPTION OF THE INVENTION

The best mode for carrying out the invention is presented in terms of its preferred embodiment, herein depicted within the accompanying illustration. However, it is pertinent to place on record the fact, that, the limitation of the invention is not solely confined to the described embodiment and a person well versed with the technical know how may well appreciate that in context of instant embodiment also there can be numerous variations without a departure/deviation from the basic concept of the invention and hence any such work/venture comes within the ambit of the instant invention, thereby implying that any such work shall be amenable to inclusion within the scope of patentability of the instant invention.

### DETAILED DESCRIPTION OF THE FIGURES

Referring now to the accompanying illijstration, a perspective view of the vehicle trailer hitch alignment device 10 (herein described as the device) is disclosed in accordance with the preferred embodiment of the present invention, generally comprising a telescopic light pole assembly; a light assembly; a telescopic pressure switch assembly; and a mounting mechanism.

The light pole assembly is essentially a hollow tubular body 30 nestled inside a second hollow tubular body 20 slightly larger in diameter. The inner tubular body 30 can slide up and down within the outer tubular body 20. A crimping collar 40 is threadably attached to the top end of the outer tubular body 20 and contacts the outer shell of the inner tubular body 30 whenever it is rotated along the threads. This action allows the user to adjust the height of the light assembly as is necessary. Both tubular bodies 20, 30 are preferably manufactured out of similar material based ultimately on strength and durability. The crimping collar 40 should be fabricated out of a flexible and lightweight material that can easily conform to the outer diameter of the inner tubular member 30.

The light mounts on top of the inner tubular member 30 and consists of a protective outer cover 50 preferably made out of a durable clear or tinted translucent plastic material and a lamp assembly 60 including a socket and conventional lamp. The light is mounted via female threads accepting the male threads located at the top end of the inner tubular member 30 and is activated by a pressure switch 90 located in the pressure switch.

The pressure switch consists of: a sleeve member 70; a sleeve support member 110; a pressure switch arm 80; a pressure switch 90; and a pivot pin 105. The sleeve member 70, sleeve support member 110, and pressure switch arm 80 are fabricated out of similar materials as that of both tubular members 20, 30 of the light pole. The pressure switch arm 80 nests inside the sleeve arm 70 and may slide in and out of the sleeve 70. The adjustment of the pressure switch arm 80 may be set with a threading means 75 that is threadably engaged to the sleeve member 70 and contacts the outer diameter of the pressure switch arm 80. Located within the sleeve member 70 and engaging the end of the pressure switch arm 80 is a spring 100 which absorbs any force acted upon the pressure switch arm 80. The sleeve support member 110 is mechanically affixed perpendicular to the outer pole mount sleeve 20 and is cut out on the top portion. A pivot pin 105 is installed horizontally through the sleeve support member 110 and through the far end of the pressure switch sleeve 70 enables the pressure switch assembly to swing down in the vertical direction to a 90° angle relative to the light pole assembly. On the distal end of the pressure switch arm 80 is a pressure switch 90 connected to a push button, preferably made of the plastic variety with a rubber button. The pressure switch 90 activates the lamp 60 in the light assembly and is connected with electrical cord that travels through the hollow pressure switch arm 80 and through the inner tubular member 30 of the light pole.

An alternate embodiment of the present invention involves the use of a laser diode mechanism and accompanying hardware for determining the distance between trailer 160 and tow vehicle 180. The pressure switch 90 and light assembly are powered by batteries located in a small housing 120 within the base, of the outer tubular member 20 of the light pole.

The mounting mechanism for the device may be any means such that the device is securably attached to the trailer frame 160 nearest the trailer jack assembly 150. According to the preferred embodiment (see accompanying illustration), spring-type clip 130 mechanically affixed to the outer tubular mount 20 for releasable attachment to the trailer jack 150. Additional means of securing the device may consist of a magnetic tape or any other means of mounting said device on the trailer jack 150.

The preferred embodiment of the present invention is designed to be used by a normal person with no special skills or training necessary.

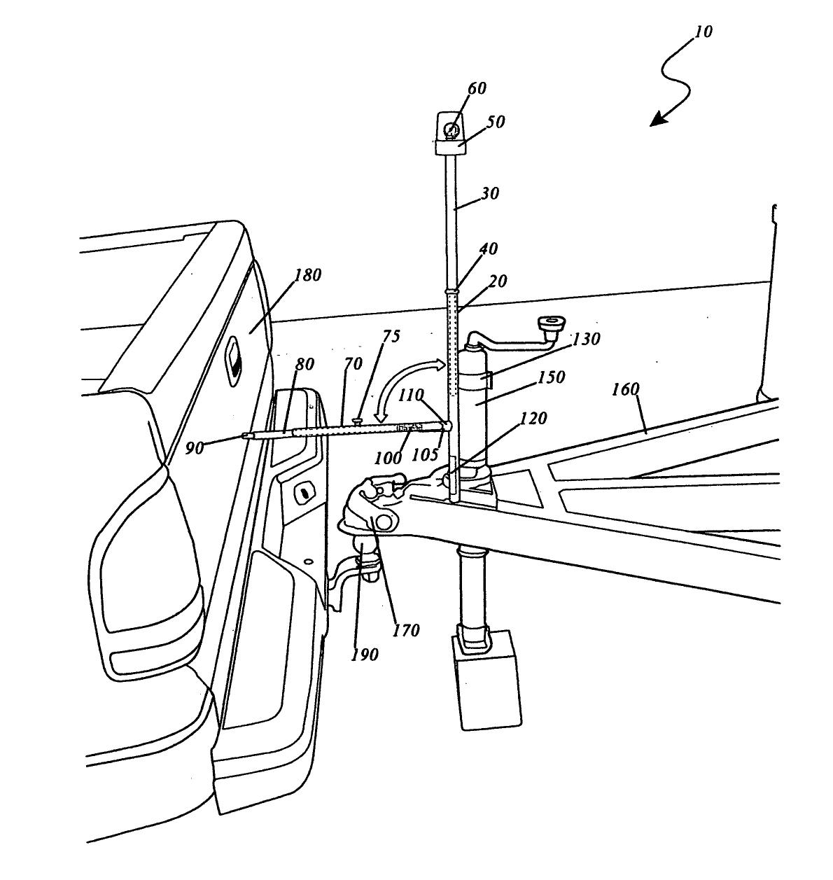

After procurement of the truck trailer hitch alignment device 10, the user then mounts the device on the center of the trailer jack 150 with the spring-type clip 130 (as depicted in FIG. 1), magnetic tape, or any other mounting system that ensures that the device remains secure. The user then verifies that the device 10 has power supplied to it either by batteries located within the bottom of the light pole 120 or via the trailer's electrical system. Then, the user positions the pressure switch assembly downward to a horizontal position about the pivot pin 105, perpendicular to the light pole assembly. Depending on the distance from the back of the tow vehicle's 180 body, the user may customize the distance of the pressure switch arm 80 by extending the pressure switch arm 80 through the sleeve 70 and securing with a threading means 75. Also, the height of the light pole assembly may be adjusted via a crimping collar 40, spring-loaded pin, or other telescopic locking device by maneuvering the inner tubular body 30 within the outer tubular body 20 as necessary. The light pole assembly must be of a particular height to allow the user to see the lamp 60 portion of the light assembly through the rear view or side view mirror within the tow vehicle 180.

After the device 10 is mounted on the trailer jack 150 and the distance of the pressure switch assembly and height of the light pole assembly has been set, the user may then proceed to back the tow vehicle 180 towards the trailer 160. When the tow vehicle 180 reaches the pressure switch 90 and contacts it, it closes a switch that results in turning on the indicator light 60, thereby visually indicating that the tow vehicle hitch 190 is in line with the coupling 170 on the trailer 160. Within the pressure switch arm 80 is a spring 100 assembly to provide some play when the tow vehicle 180 depresses the switch 90. This action provides a safety factor from any damage to the rear of the tow vehicle 180.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A vehicle trailer hitch alignment device for aligning a vehicle hitch to a trailer comprising:
a light pole assembly having a first end and a second end;
a light assembly for providing lighting arrangement detachably coupled to said light pole assembly at said first end; and
a pressure switch assembly pivotally mounted towards said second end of said light pole assembly and electrically connected to said light assembly.

2. A light pole assembly for a vehicle trailer hitch alignment device having a light assembly and a pressure switch assembly, comprising:
a first and second coaxial tubular longitudinal bodies having top ends, said first tubular body capable of sliding inside said second tubular body;
an adjustable collar threadably attached to said second tubular body for regulating said sliding motion of said first tubular body inside said second tubular body thereby capable of adjusting the height of said light pole assembly.

3. A pressure switch assembly for a vehicle trailer hitch alignment device having a light assembly and a light pole assembly comprising:
an elongated cylindrical sleeve member attached to a sleeve support member pivotally coupled to said light pole assembly by a pivot pin, said sleeve member further having a threading means;
a pressure switch arm having a first end and a second end, capable of adjustably sliding inside said cylindrical sleeve member regulated by said threading means and connected to a pressure switch at said first end, said pressure switch electrically connected to said light assembly; and
an absorbing means interiorly placed inside said pressure arm switch at said second end for absorbing any force acted upon said pressure arm;

4. A method of aligning a tow vehicle hitch with a trailer having a coupling, using a vehicle trailer hitch alignment device having a pressure switch assembly, a light assembly and a light pole assembly, the method comprising:
mounting said device on a trailer;
setting the distance of the pressure switch assembly having a pressure switch by pivotally orienting said pressure switch assembly;
setting the height of the light pole assembly; and
reversing said vehicle towards said trailer wherein as the vehicle comes in contact with the pressure switch of said pressure switch assembly provides an indication through said light assembly thereby indicating an operator that said vehicle hitch is in line with said coupling of said trailer.
